(19) United States
(12) Patent Application Publication
(10) Pub. No.: US 2002/0109321 A1
(43) Pub. Date: Aug. 15, 2002

(54) Thermally insulated container for juvenile stroller push handle

(76) Inventors: Dennis M. Turner, Mooresville, IN (US); Andrew Mendenhall, Indianapolis, IN (US); Paul T. Zink, Anderson, IN (US); Nancy J. Rasche, Lebanon, IN (US)

Correspondence Address: BARNES & THORNBURG, 11 SOUTH MERIDIAN, INDIANAPOLIS, IN, 46204

(21) Appl. No.: 10/044,576

(22) Filed: Jan. 11, 2002

Related U.S. Application Data
(60) Provisional application No. 60/261,605, filed on Jan. 12, 2001.

(51) Int. Cl. B62B 9/26; B62B 7/04

(52) U.S. Cl. 280/47.38; 280/647

(57) ABSTRACT

A juvenile stroller includes a stroller frame including a push handle and a thermally insulated container carried on the push handle. In some embodiments, the thermally insulated container is suspended from a console tray mounted on a pair of tubular handle arms included in the push handle. In other embodiments, the thermally insulated container is coupled to a lid frame mounted on the tubular handle arms and a lid is coupled to the lid frame to open and close a top opening into the container.

This application claims priority under 35 U.S.C. 119(e) to U.S. Provisional Application Serial No. 60/261,605, filed Jan. 12, 2001, which is expressly incorporated by reference herein.

### BACKGROUND AND SUMMARY

The present disclosure relates to juvenile strollers, and particularly to stroller accessories. More particularly, the present disclosure relates to storage units adapted to be carried onboard a juvenile stroller.

Juvenile strollers are being adapted to carry various child-care items in handy onboard locations in addition to carrying infants or other young children. Caregivers appreciate the convenience of being able to store child-care items onboard the stroller so that those items will be available to the caregiver when the stroller is being used to transport a child away from home or vehicle.

According to the present disclosure, a juvenile stroller includes a stroller frame and a thermally insulated container configured to store items in a temperature-controlled environment. The container is coupled to a console tray mounted on a push handle included in the stroller frame to move therewith.

In some embodiments, the thermally insulated container is suspended from the console tray and configured to include an interior storage region accessible through an access opening formed in a rear wall facing toward a person pushing the stroller. In another embodiment, the thermally insulated container is formed to include an interior storage region having a top opening and is coupled to a lid frame mounted on the push handle so that a lid mounted on the lid frame can be opened and closed to control access to the interior storage region through the top opening. The interior storage region of such container can also be accessed through an access opening formed in a rear wall facing toward a person pushing the stroller.

Additional features of the disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a portable thermally insulated push handle container in accordance with a first embodiment of this disclosure adapted to be mounted in a container receiver formed in a console tray mounted on the push handle of a juvenile stroller;

FIG. 2 is a perspective view of a portable thermally insulated container adapted to be placed in a basket coupled to a stroller frame and arranged to lie under a seat coupled to the stroller frame as shown in FIG. 1;

FIG. 3 is a perspective view similar to FIG. 2 showing the container of FIG. 2 after it has been opened;

FIG. 4 is a perspective view of a portable thermally insulated push handle container in accordance with a second embodiment of this disclosure adapted to be mounted in a container receiver formed in a console tray mounted on the push handle of a juvenile stroller;

FIG. 5 is a perspective view of a portable thermally insulated container adapted to be coupled to a rear portion of a thermally insulated container arranged to lie under a seat coupled to the stroller frame as shown in FIG. 4;

FIG. 6 is a rear perspective view of the thermallly insulated push handle container of FIG. 4 showing a rear-access cover in an opened position;

FIG. 7 is a perspective view of a portable thermally insulated push handle container in accordance with a third embodiment of this disclosure adapted to be mounted on handle arms included in a push handle of a juvenile stroller, the juvenile stroller further including a thermally insulated container mounted under a seat included in the juvenile stroller and formed to include a front-access cover in an opened position; and

FIG. 8 is a rear perspective view of the push handle container of FIG. 7 showing a rear-access cover in an opened position.

### DETAILED DESCRIPTION OF THE DRAWINGS

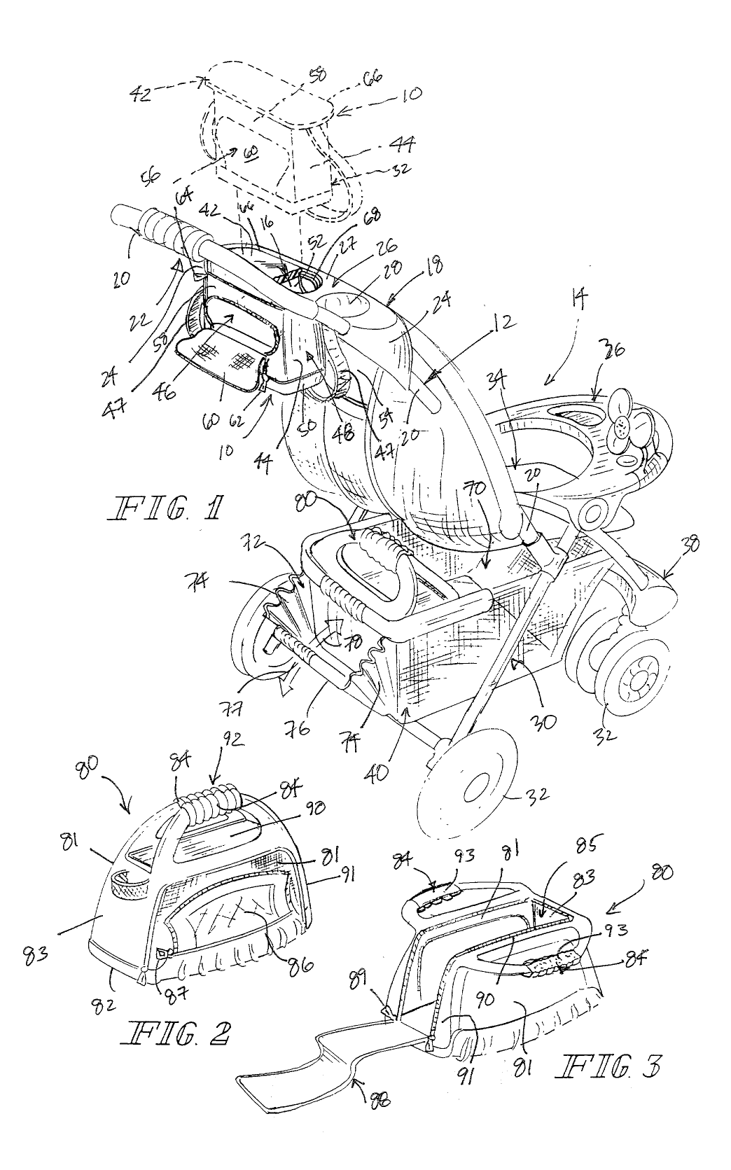

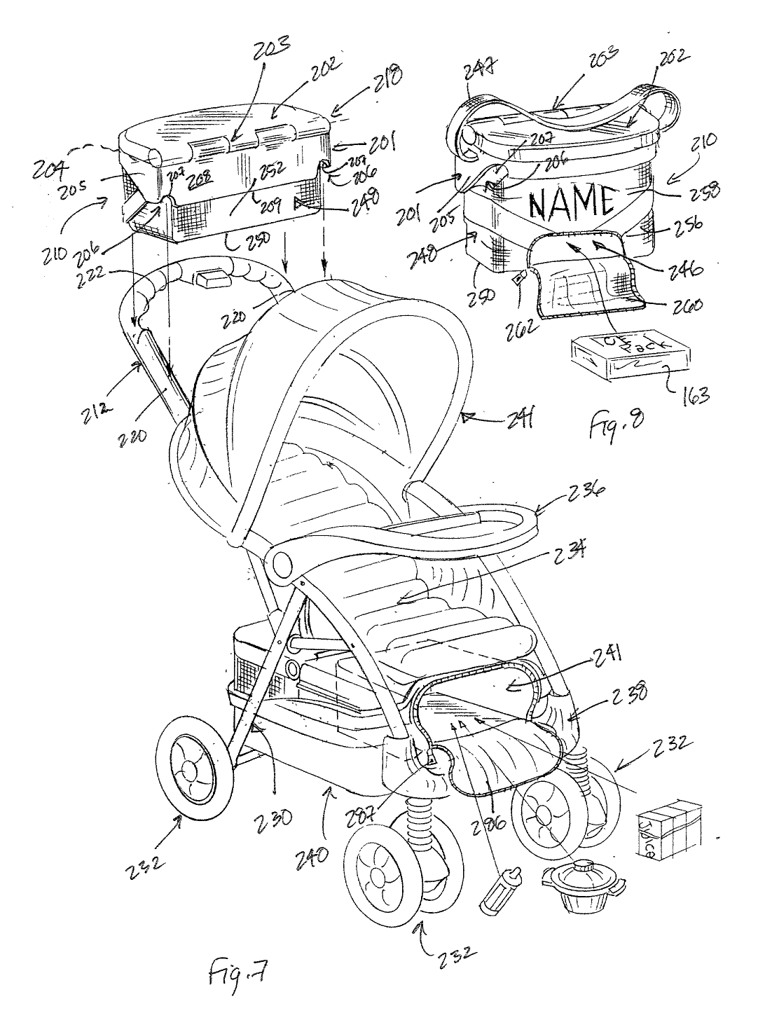

A thermally insulated container 10 is configured to store items in a temperature-controlled environment from a perch on the push handle 12 of a juvenile stroller 14 as shown, for example, in FIG. 1. A second thermally insulated push handle container 110 is illustrated in FIGS. 4 and 6, while a third thermally insulated push handle container 210 is shown in FIGS. 7 and 8.

Each container 10, 110, 210 is configured to provide a thermally insulated case in which caregivers can store child-care or other items to be maintained in a cooled environment. Such a thermally insulated case is adapted to receive an ice pack or any other suitable low-temperature source to lower the temperature in an interior storage region to a selected temperature target or range. Such a thermally insulated case is also adapted to receive a heat pack or any other suitable high-temperature source. Such containers function as a thermally insulated storage region to maintain products stored therein at a desired temperature relative to an ambient temperature outside the storage region for a desired period of time so that cold products stored in the thermally insulated storage region will be maintained at their cold temperature and warm products stored in the thermally insulated storage region will be maintained at their warm temperature.

Container 10 is configured to be located in a container receiver 16 included in a console tray 18 that is mounted on push handle 12 of stroller 14 as shown, for example, in FIG. 1. Push handle 12 includes a pair of spaced-apart handle arms 20 and a grip handle 22 coupled to handle arms 20. Console tray 18 includes a pair of spaced-apart side walls 24 and a top plate 26 formed to include an aperture-defining container receiver 16. Each side wall 24 is configured to mount on one of handle arms 20 to support console tray 18 on push handle 12 in a location near grip handle 22. Top plate 26 is also formed to include a cup holder 28 configured to hold a cup, bottle, juice box, or other item. It is within the scope of this disclosure to provide other storage receptacles on console tray 18 (and the other console trays disclosed herein) to provide a convenient storage platform on push handle 12 within easy reach of a caregiver pushing the stroller 14.

Juvenile stroller 14 includes a frame 30 and wheels 32, a seat 34, a tray 36, a footrest 38, and a basket 40 of any suitable shape and coupled to frame 30 in any suitable manner. The push handle 12 is a part of frame 30 and may have any suitable shape and size. Basket 40 is arranged to lie under seat 34 to provide additional storage capacity onboard stroller 14.

As shown in FIG. 1, thermally insulated container 10 includes a basket support frame 42 and a basket 44 formed to include an interior storage region 46 and suspended from basket 44. Console tray 18 includes a top surface 27 on top plate 26 that is formed to include an opening into the container receiver 16 formed in top plate 26 as shown, for example, in FIG. 1. Basket 44 is sized to pass through the opening in top surface 27 of top plate 26 during movement of basket support frame 42 into container receiver 16 formed in the top plate 26 of tray console 18. A carrying strap 47 is coupled to either basket support frame 42 or basket 44 to facilitate handling of container 10 when container 10 is separated from console tray 18.

In the illustrated embodiment, basket support frame 42 is made of a plastics material and basket 44 includes walls 48 coupled to basket support frame 42 and made of a pliable material and a floor 50 coupled to walls 48 and made of a plastics material. It is within the scope of this disclosure to provide walls 48 and floor 50 with a wide variety of suitable shapes using any suitable materials. Walls 48 include a front wall 52 arranged to face toward a seat back 54 included in seat 34 and a rear wall 56 arranged to face away from seat back 54 as shown, for example, in FIG. 1.

Rear wall 56 of basket 44 includes a fixed portion 58 formed to include an access opening into interior storage region 46, a cover portion or door 60, and means for fastening cover portion 60 to fixed portion 58 to permit movement of cover portion 60 relative to fixed portion 58 to open and close the access opening into interior storage region 46. Although the fastening means is a zipper 62 in the illustrated embodiment, it is within the scope of this disclosure to use any suitable fastener such as snaps, buttons, ties, and hook-and-loop fasteners. It is within the scope of this disclosure to provide another fastener such as zipper 64 along an interface between basket walls 48 and basket support frame 42 to provide a closable top opening into interior storage region 46 that is usable, for example, when the thermally insulated container 10 is separated from console tray 18.

In the illustrated embodiment shown in FIG. 1, a perimeter edge 66 of basket support frame 42 sets on an interior ledge 68 formed in top plate 26 of console tray 18 and associated with container receiver 16 to suspend thermally insulated container 10 in container receiver 16. In such a suspended position, basket walls 48 extend downwardly from top plate 26 to lie under console tray 18 and basket 44 lies in spaced-apart relation to cup holder 28. It is within the scope of this disclosure to use other connectors to establish a fixed position of basket support frame 42 in container receiver 16. It is also within the scope of this disclosure to mount perimeter edge 66 of basket support frame 42 on top surface 27 or another part of top plate 26 of console tray 18. When container 10 is located in container receiver 16, carrying strap 47 is arranged to hang or otherwise lie below console tray 18 in an out-of-the-way location.

As shown, for example, in FIG. 1, the basket 40 arranged to lie under seat 34 is formed to include a large storage cavity 70 of fixed volume and a smaller expandable cavity 72 of variable volume located to the rear of large storage cavity 70. Corrugated foldable side walls 74 and a grippable rear wall 76 cooperate to form expandable cavity 72 and can be moved in directions 77 or 78 to change the volume of expandable cavity 72.

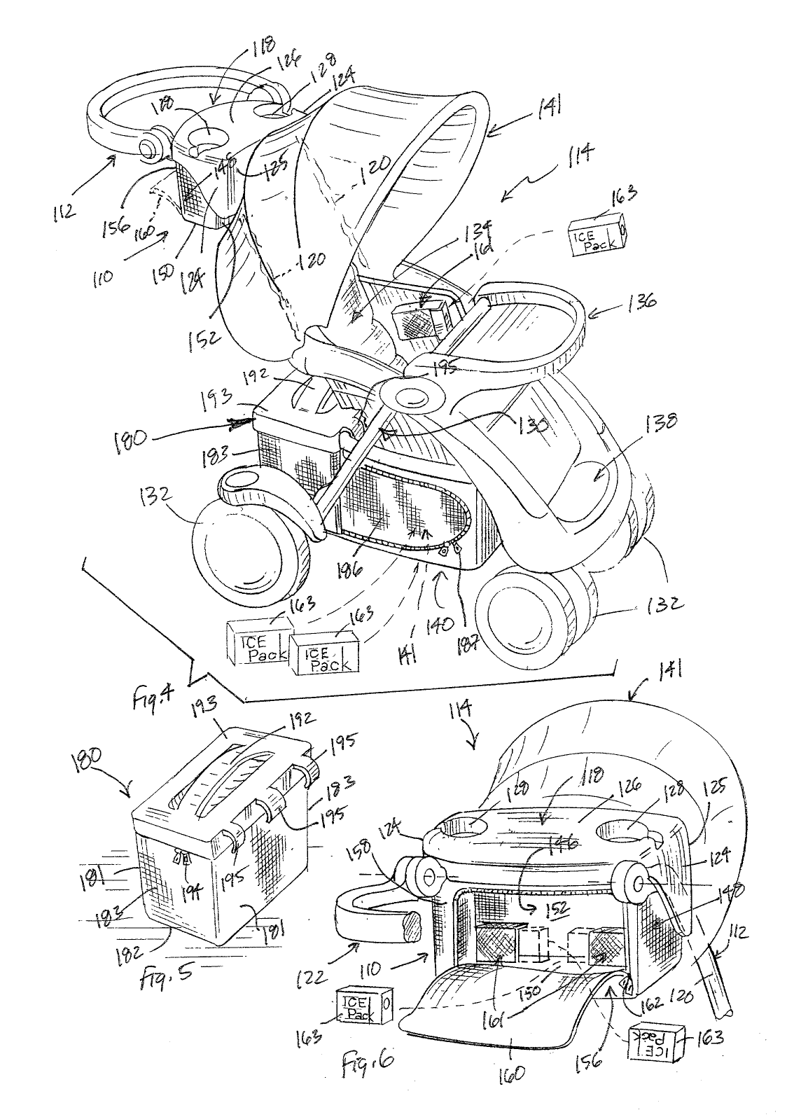

A thermally insulated container 80, configured to be stored in underseat basket 40 of stroller 14, as shown in FIG. 1, is shown in FIGS. 2 and 3. Container 80 includes side walls 81, floor 82 coupled to side walls 81, end wall 83 coupled to side walls 81 and floor 82, and a handle portion 84 coupled to each of side walls 81. Container 80 is formed to include an interior storage region 85 that is accessible by opening closure 86 using fastener 87 or by opening closure 88 using fastener 89. Closure 86 is located in one of side walls 81 while closure 88 is located in a top portion 90 and an end wall 91. Closure 88 includes side portion 88a and top portion 88b. When closed as shown, for example, in FIG. 2, handle portions 84 mate to form handle 92 and hook-and-loop fasteners 93 or other fasteners can be used to couple one handle portion 84 to the other handle portion 84.

A thermally insulated container 110 associated with a console tray 118 mounted on a push handle 112 included in a stroller 114 is illustrated in FIGS. 4 and 6. Stroller 114 includes frame 130, wheels 132, seat 134, tray 136, footrest 138, basket 140, and canopy 141. Push handle 112 includes two spaced-apart handle arms 120 and a grip handle 122 coupled to handle arms 120.

Console tray 118 includes a pair of spaced-apart side walls 124, a front wall 125, and a top plate 126 formed to include two cup holders 228. Top plate 126 is coupled to each of side walls 124 and arranged to span a space therebetween as suggested in FIG. 6. Front wall 125 is also coupled to each of side walls 124 and is coupled to a front edge of top plate 126 as shown best in FIG. 4. Top plate 126, front wall 125, and side walls 124 cooperate to define a container receiver 116 therebetween as shown best in FIG. 6. Container 110 is mounted in container receiver 116 to extend downwardly from top plate 126 and lie in a space between handle arms 120.

Container 110 includes walls 148 coupled to top plate 116 and/or other portions of console tray 118 and a floor 150 coupled to walls 148. In the illustrated embodiment, walls 148 and floor 150 are made of a pliable material. Walls 148 include a front wall 152 arranged to face toward front wall 125 of console tray 118 and a rear wall 156 arranged to face away from console tray wall 125 as in FIGS. 4 and 6.

Rear wall 156 of container 110 includes a fixed portion 158 formed to include an access opening into an interior storage region 146 formed in container 110, a cover portion or door 160, and means for fastening cover portion 160 to fixed portion 158 to permit movement of cover portion 160 relative to fixed potion 158 to open and close the access opening into interior storage region 146. Although the fastening means is a zipper 162 in the embodiment illustrated in FIGS. 4 and 6, it is within the scope of this disclosure to use any suitable fasteners such as snaps, buttons, ties, and hook-and-loop fasteners. It is also within the scope of this disclosure to provide means 161 for holding ice packs 163 or heat packs (not shown) in predetermined locations inside interior storage region 146 as suggested in FIG. 6. In the illustrated embodiment, such pack holder means 161 includes interior walls coupled to walls 148 and floor 150 to form a pack receiver chamber therein. It is also within the scope of this disclosure to mount a pack holder 161 on or in close proximity to seat 134 as shown, for example, in FIG. 4 to provide means for cooling or warming a juvenile at rest on the seat 134.

As shown, for example, in FIG. 4, the basket 140 arranged to lie under seat 134 is formed to include a thermally insulated interior storage region 141 that is accessible through a side wall by opening closure 186 using fastener 187. Further, a thermally insulated container 180, configured to be coupled to a rear portion of underseat basket 14 as shown in FIG. 4, is shown in FIG. 5. Container 180 includes side walls 181, floor 182 coupled to side walls 181, end walls 183 coupled to side walls 181 and floor 182, and a handle 192 coupled to a lid 193. Lid 193 is fastened to walls 181, 183 by zipper 194. Hooks 195 are coupled to lid 193 and arranged to provide means for mating with underseat basket 140 to support container 180 on basket 140 a shown, for example, in FIG. 4.

A thermally insulated container 210 associated with a console tray 218 configured to mount on a push handle 212 included in a stroller 214 is illustrated in FIGS. 7 and 8. Stroller 214 includes frame 230, wheels 232, seat 234, tray 236, footrest 238, basket 240, and canopy 241. Push handle 212 includes two spaced-apart handle arms 220 and a grip handle 222 coupled to handle arms 220.

Console tray 218 includes a lid frame 201 configured to mount on handle arms 220 of push handle 212 and a lid or top plate 202 mounted on lid frame 201 for movement relative to lid frame 201 to open and close a top opening formed in thermally insulated container 210 and located under lid 202. In the illustrated embodiment, lid 202 is mounted on a hinge 203 to pivot about a hinge axis 204 relative to lid frame 201. A carrying strap 247 is coupled to lid frame 201 to facilitate handling of container 210 when it is separated from stroller 214.

Container 210 includes walls 248 coupled to lid frame 201 and a floor 250 coupled to walls 248. Walls 248 and floor 250 cooperate to form an interior storage region 246 in container 210. In the illustrated embodiment, wall 248 and floor 250 are made of a pliable material. Walls 148 include a front wall 252 arranged to face toward canopy 241 and a rear wall 256 arranged to face away from canopy 241 as suggested in FIGS. 7 and S.

Rear wall 256 of container 210 includes a fixed portion 258 formed to include an access opening into an interior storage region 246 formed in container 210, a cover portion or door 260, and means for fastening cover portion 260 to fixed portion 258 to permit movement of cover portion 260 relative to fixed portion 258 to open and close the access opening into interior storage region 246. Although the fastening means is a zipper 262 in the embodiment illustrated in FIGS. 7 and 8, it is within the scope of this disclosure to use any suitable fastener such as snaps, buttons, ties, and hook-and-loop fasteners.

Lid frame 201 of console tray 218 includes a pair of side walls 205 arranged to lie in spaced-apart relation to one another to define a container receiver 216 therebetween as suggested in FIGS. 7 and 8. Each side wall 205 is formed to include an inclined channel 206 defined by a curved concave wall 207 shaped and sized to receive a tubular section of one of the handle arms 220 therein. Lid frame 201 further includes a rear wall 208 coupled to each of the side walls 205. Rear wall 208 is “cut away” as shown, for example, in FIG. 7 to provide lowermost openings into each of the inclined channels 206 formed in the side walls 205. Rear wall 208 includes a lowermost edge 209 and floor 250 is arranged to lie below and in spaced-apart relation to lowermost edge 209 of rear wall 208.

As shown, for example, in FIG. 7, the basket 240 arranged to lie under seat 234 is formed to include a thermally insulated interior storage region 241. Interior storage region 241 is accessible through a front wall located between a front edge of seat 234 and footrest 238 by opening a closure 286 using fastener 287.

1. A juvenile stroller comprising
a stroller frame including a push handle,
a console tray mounted on the push handle and formed to include a container receiver therein, and
a thermally insulated container located in the container receiver and coupled to the console tray.

2. The juvenile stroller of claim 1, wherein the container includes a basket support frame coupled to the container receiver and a basket formed to include an interior storage region and suspended from the basket support frame.

3. The juvenile stroller of claim 2, wherein the console tray includes a top surface formed to include an opening into the container receiver and the basket is sized to pass through the opening in the top surface during movement of the basket support frame into the container receiver.

4. The juvenile stroller of claim 3, wherein the basket includes a floor, walls extending from the basket support frame to the floor, and a door mounted for movement relative to the walls to open and close an access opening formed in the walls and arranged to provide a portal into the interior storage region formed in the basket.

5. The juvenile stroller of claim 3, wherein the console tray further includes a cup holder having an opening in the top surface and extending below the top surface to lie in spaced-apart relation to the basket.

6. The juvenile stroller of claim 2, wherein the basket support frame is made of a plastics material and the basket includes walls coupled to the basket support frame and made of a pliable material.

7. The juvenile stroller of claim 6, wherein the basket further includes a floor coupled to the walls and made of a plastics material.

8. The juvenile stroller of claim 6, wherein the juvenile stroller further includes a seat back positioned to lie adjacent to the push handle, the walls include a front wall arranged to face toward the seat back and a rear wall arranged to face away from the seat back, the front wall is positioned to lie between the seat back and the rear wall, and the rear wall includes a fixed portion formed to include an opening into the interior storage region, a cover portion, and means for fastening the cover portion to the fixed portion to permit movement of the cover portion relative to the fixed portion to open and close the opening into the interior storage region.

9. The juvenile stroller of claim 2, wherein the basket includes a floor, walls extending from the basket support frame to the floor, and a door mounted for movement relative to the walls to open and close an access opening formed in the walls and arranged to provide a portal into the interior storage region formed in the basket.

10. The juvenile stroller of claim 2, wherein the container further includes a carrying strap coupled to the basket support frame and arranged to lie under the console tray when the basket support frame is coupled to the container receiver.

11. The juvenile stroller of claim 2, wherein the basket is positioned to lie in spaced-apart relation to the push handle.

12. The juvenile stroller of claim 1, wherein the push handle includes a pair of spaced-apart inclined handle arms, the console tray includes a pair of spaced-apart side walls, each side wall is configured to mount on one of the handle arms to support the console tray on the push handle, the console tray further includes a top plate coupled to each of the side walls and arranged to span a space therebetween, the top plate and side walls cooperate to define the container receiver therebetween, and the container is mounted in the container receiver to extend downwardly from the top plate and lie in a space between the handle arms.

13. The juvenile stroller of claim 12, wherein the container includes walls coupled to the top plate and a floor coupled to the walls.

14. The juvenile stroller of claim 13, wherein the floor and each of the walls is made of a pliable material.

15. The juvenile stroller of claim 13, wherein the juvenile stroller further includes a seat back positioned to lie adjacent to the push handle, the walls include a front wall arranged to face toward the seat back and a rear wall arranged to face away from the seat back, the front wall is positioned to lie between the seat back and the rear wall, and the rear wall includes a fixed portion formed to include an opening into the interior storage region, a cover portion, and means for fastening the cover portion to the fixed portion to permit movement of the cover portion relative to the fixed portion to open and close the opening into the interior storage region.

16. The juvenile stroller of claim 1, wherein the push handle includes a pair of spaced-apart inclined tubular handle arms, the console tray includes a pair of side walls arranged to lie in spaced-apart relation to one another to define the container receiver therebetween, and each side wall is formed to include an inclined channel defined by a curved concave wall shaped and sized to receive a portion of one of the tubular handle arms therein.

17. The juvenile stroller of claim 16, wherein the console tray further includes a rear wall coupled to each of the side walls and the rear wall is cut away to provide lowermost openings into each of the inclined channels formed in the side walls.

18. The juvenile stroller of claim 17, wherein the rear wall includes a lowermost edge and the container includes walls coupled to the console tray and a floor coupled to the walls and arranged to lie below and in spaced-apart relation to the lowermost edge of the rear wall.

19. The juvenile stroller of claim 17, wherein the console tray further includes a top plate mounted for pivotable movement about a hinge axis relative to the rear wall to open and close a top opening into an interior storage region formed in the container.

20. The juvenile stroller of claim 16, wherein the container includes walls coupled to the console tray and a floor coupled to the walls, the walls and floor cooperate to form an interior storage region in the container, one of the walls includes a fixed portion formed to include an access opening into the interior region along the floor, a cover portion, and means for fastening the cover portion to the fixed portion to permit movement of the cover portion relative to the fixed portion to open and close the access opening into the interior storage region, and the console tray further includes a top plate is mounted for pivotable movement about a hinge axis relative to the side walls to open and close a top opening into the interior storage region.

21. A juvenile stroller comprising
a stroller frame including a push handle,
a console tray mounted on the push handle, the console tray including a top plate formed to include a cup holder and walls arranged to extend downwardly from the top plate to cover a portion of the push handle, the top plate and the walls cooperating to define a downwardly opening container receiver, and
a thermally insulated container located in the container receiver under the top plate, the container including a floor arranged to lie under and in spaced-apart relation to the top plate and walls extending downwardly in a direction away from the top plate to the floor, one of the walls being formed to include an access opening into an interior storage region formed in the container and a cover portion mounted for movement relative to the console tray to open and close the access opening.

22. A juvenile stroller comprising
a stroller frame including a push handle,
a thermally insulated container formed to include an interior storage region and a top opening into the interior storage region, and
a console tray including a lid frame mounted on the push handle and coupled to the container and a lid mounted on the lid frame for movement relative to the lid frame to open and close the top opening formed in the container.
